(19) United States
(12) Patent Application Publication
(10) Pub. No.: US 2015/0278644 A1
(43) Pub. Date: Oct. 1, 2015

(54) IMAGE FORMING APPARATUS

(71) Applicant: KYOCERA Document Solutions Inc., Osaka (JP)

(72) Inventors: Masaru SATO, Osaka (JP); Kazunori GOTO, Osaka (JP); Toshiya MIYAI, Osaka (JP)

(73) Assignee: KYOCERA DOCUMENT SOLUTIONS INC., Osaka (JP)

(21) Appl. No.: 14/668,376

(22) Filed: Mar. 25, 2015

(30) Foreign Application Priority Data
Mar. 28, 2014 (JP) 2014-069067

(51) Int. Cl. G06K 15/00; G06K 15/02

(52) U.S. Cl. CPC G06K 15/002; G06K 15/02

(57) ABSTRACT

An image forming apparatus includes an image forming section, a display section, an input section, and a control section. The image forming section forms an image. The display section displays a question. The input section receives an answer to the question as input from a user. The control section causes the image forming section to form an image in response to input of the answer.

### INCORPORATION BY REFERENCE

The present application claims priority under 35 U.S.C. §119 to Japanese Patent Application No. 2014-069067, filed Mar. 28, 2014. The contents of this application are incorporated herein by reference in their entirety.

### BACKGROUND

The present disclosure relates to image forming apparatuses.

Image forming apparatuses of some type have an application function (e.g., an overlay printing function). Some image forming apparatus of such a type displays a direction how to operate the application function on a display section. A user can simulate the application function of the image forming apparatus to learn how to operate the application function.

### SUMMARY

An image forming apparatus according to an aspect of the present disclosure includes an image forming section, a display section, an input section, and a control section. The image forming section forms an image. The display section displays a question. The input section is configured to receive an answer to the question as input from user. The control section causes the image forming section to form an image in response to input of the answer.

### BRIEF DESCRIPTION OF THE DRAWINGS

FIG. 1 is a block diagram illustrating an image forming apparatus according to the first embodiment of the present disclosure.

FIG. 2 is an illustration indicating a question displayed on a display section of the image forming apparatus according to the first embodiment of the present disclosure.

FIG. 3 is a flowchart depicting an image forming method implemented in the image forming apparatus according to the first embodiment of the present disclosure.

FIG. 4 is a block diagram illustrating an image forming apparatus according to the second embodiment of the present disclosure.

FIGS. 5A and 5B are illustrations each indicating a determination result displayed on a display section of the image forming apparatus according to the second embodiment of the present disclosure.

FIG. 6 is a diagram illustrating the image forming apparatus and external devices connected to the image forming apparatus according to the second embodiment of the present disclosure.

FIG. 7 is a block diagram illustrating the image forming apparatus according to the second embodiment of the present disclosure.

FIG. 8 is a cross sectional view illustrating the image forming apparatus according to the second embodiment of the present disclosure.

FIG. 9 is a flowchart depicting an image forming method implemented in the image forming apparatus according to the second embodiment of the present disclosure.

FIG. 10 is a block diagram illustrating an image forming apparatus according to the third embodiment of the present disclosure.

FIG. 11 is a flowchart depicting an image forming method implemented in the image forming apparatus according to the third embodiment of the present disclosure.

### DETAILED DESCRIPTION

Embodiments of the present disclosure will be described below with reference to the accompanying drawings. Note that the same reference numerals are assigned to the same or corresponding elements in the drawings, and the description thereof will not be repeated.

### First Embodiment

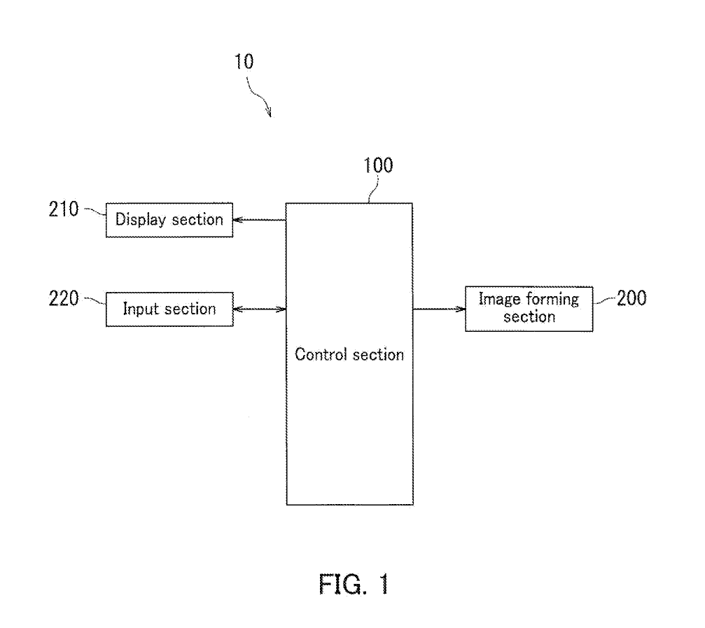

The basic principle of an image forming apparatus 10 according to the first embodiment of the present disclosure will be described below with reference to FIG. 1. FIG. 1 is a block diagram illustrating the image forming apparatus 10. The image forming apparatus 10 includes an image forming section 200, a display section 210, an input section 220, and a control section 100.

The image forming section 200 forms an image. The display section 210 displays a question 60. The input section 220 receives an answer to the question 60 as input from a user. The control section 100 causes the image forming section 200 to form an image in response to input of an answer.

According to the first embodiment, the control section 100 causes the image forming section 200 to form an image in response to input of an answer. In other words, unless a user input an answer, no image formation is started. This can enable the user to experience repetitive learning through answering a question presented each time the user uses the image forming function of the image forming apparatus 10.

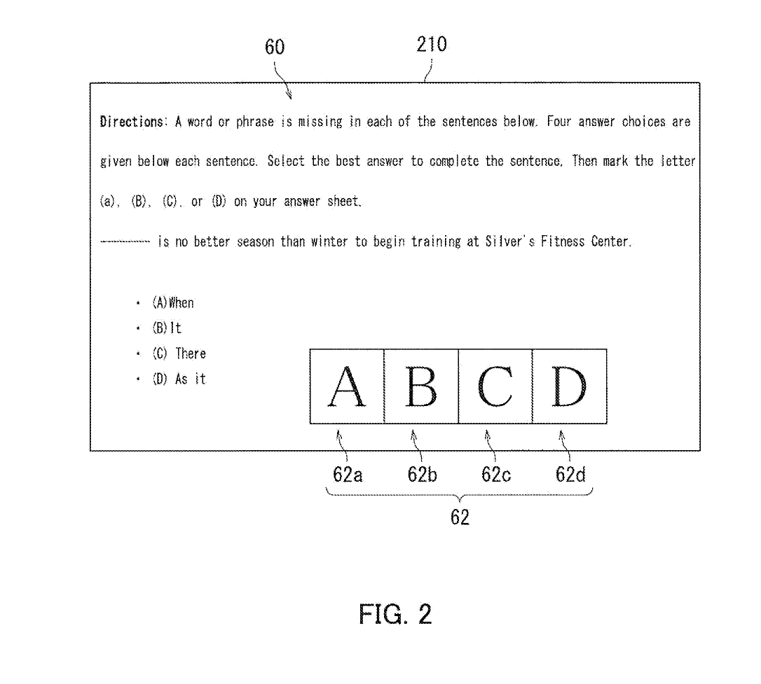

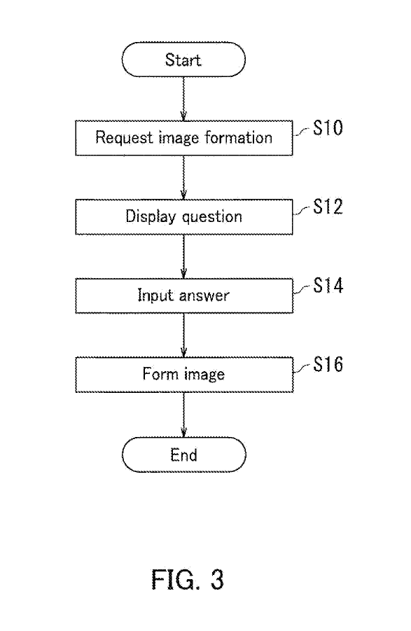

Image forming operation will be described in detail with reference to FIGS. 1-3. FIG. 2 is a diagram indicating a question 60 displayed on the display section 210 of the image forming apparatus 10. FIG. 3 is a flowchart depicting an image forming method implemented in the image forming apparatus 10 according to the first embodiment. The display section 210 displays a set of a question sentence and alternatives as the question 60. The display section 210 further displays a button group 62 serving as the input section 220. The button group 62 includes buttons 62a, 62b, 62c, and 62d.

The button 62a in the button group 62 corresponds to an alternative A. The button 62b corresponds to an alternative B. The button 62c corresponds to an alternative C. The button 62d corresponds to an alternative D. The following describes an example of a user's operation to cause the image forming apparatus 10 to execute a scan function in the first embodiment.

Note that the image forming apparatus 10 has a plurality of functions including a copy function, scan function, printing function, and facsimile function and executes operations corresponding to the respective functions. Alternatively, the image forming apparatus 10 in the present disclosure may be an apparatus having a single function such as a copier, a scanner, a printer, or a facsimile machine.

At Step S10, the user loads a reading target (e.g., printed matter or a photograph) on the image forming apparatus 10. To request image formation, the user presses a start button (not shown) for causing the image forming apparatus 10 to execute the scan function. At Step S12, the control section 100 causes the display section 210 to display a question 60 and the button group 62, as illustrated in FIG. 2. At Step S14, the user selects any one of the alternatives and touches any of the buttons 62a-62d corresponding to the selected alternative for input of an answer. At Step S16, the control section 100 causes the image forming section 200 to form an image.

The question 60 displayed on the display section 210 may relate to common sense or the internal rules in a company to which the user belongs, for example. The display section 210 displays the button group 62. Alternatively, the button group 62 may be physically provided in the image forming apparatus 10, like a numeric keypad, a keyboard, or switches.

As has been described with reference to FIGS. 1-3, according to the present embodiment, each time the user requests the image forming apparatus 10 to form an image, the image forming apparatus 10 makes the user answer a question. Thus, the user can learn each time the user uses the image forming apparatus 10. This can enable the user to experience repetitive learning through repetitive use of the image forming apparatus 10.

### Second Embodiment

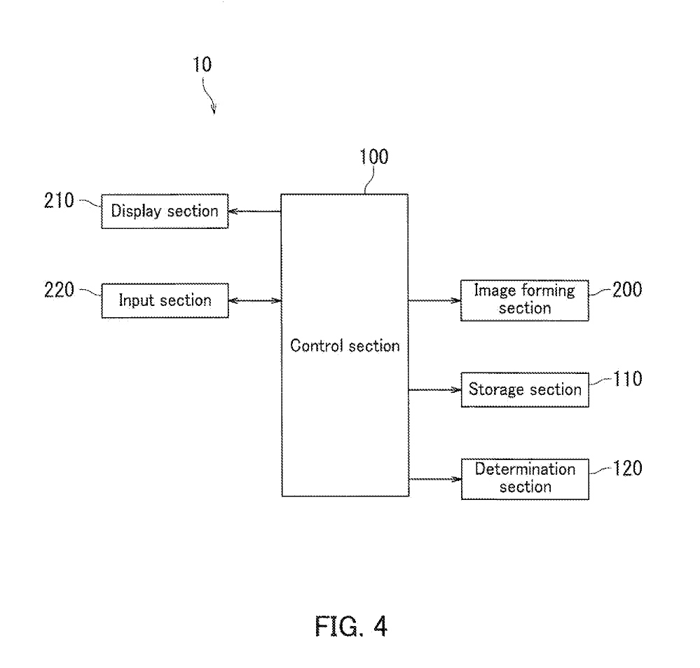

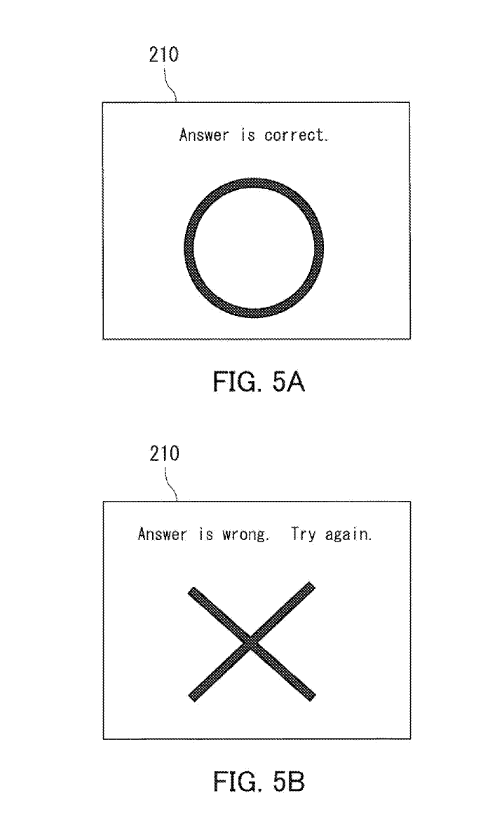

The image forming apparatus 10 according to the second embodiment of the present disclosure will be described with reference to FIGS. 2, 4, 5A, and 5B. FIG. 4 is a block diagram illustrating the image forming apparatus 10. FIGS. 5A and 5B are diagrams each indicating a determination result displayed on the display section 210. Here, the correct answer to the question 60 in FIG. 2 is indicated at the alternative C. The image forming apparatus 10 further includes a storage section 110 and a determination section 120. Note that in the image forming apparatus 10 according to the second embodiment, the same reference numerals are assigned to the elements corresponding to those in the first embodiment, and duplicate description shall be omitted.

The storage section 110 stores a plurality of questions and corresponding correct answers. The determination section 120 determines whether or not an answer input by the user matches the correct answer to a question being displayed on the display section 210.

A user's operation to cause the image forming apparatus 10 to execute the scan function will now be described as an example of the use of the image forming apparatus 10 in the second embodiment.

The user loads a reading target on the image forming apparatus 10. The user presses the start button (not shown) for causing the image forming apparatus 10 to execute the scan function. In other words, the user requests image formation. Then, as illustrated in FIG. 2, a question 60 and the button group 62 serving as the input section 220 are displayed on the display section 210. The user is allowed to input an answer by touching any of the buttons 62a-62d of the button group 62.

When the user inputs an answer by touching the button 62c in the button group 62 as the alternative C corresponding to the correct answer, the input answer matches the correct answer to the question 60. The determination section 120 accordingly determines that the input answer matches the correct answer. The control section 100 then causes the display section 210 to display the determination result, as illustrated in FIG. 5A, and causes the image forming apparatus 10 to execute the scan function. Upon inputting an answer that matches the correct answer, the user is allowed to use the image forming apparatus 10.

When the user inputs an answer by touching any one of the buttons 62a, 62b, 62d in the button group 62 respectively representing the alternatives A, B, and D corresponding to wrong answers, the input answer mismatches the correct answer to the question 60. The determination section 120 accordingly determines that the input answer mismatches the correct answer. The control section 100 then causes the display section 210 to display the determination result, as illustrated in FIG. 5B, and display the question 60 again.

The user has to continue inputting an answer until the determination section 120 determines that an input answer matches the correct answer to the question 60. Upon a match between an input answer and the correct answer being determined, the control section 100 causes the image forming section 200 to execute the scan function.

The storage section 110 stores an answered question. The answered question means a question to which the user has input an answer, among the plurality of questions. The control section 100 selects a question to be displayed on the display section 210 from the questions by referencing the answered question stored in the storage section 110. Thus, the control section 100 can select a question to which no answer has been input from the questions in a preferential manner by referencing the answered question stored in the storage section 110 and cause the display section 210 to display it. As a result, the display section 210 displays various questions to which no answers have been input by the user, thereby enabling repetitive answering of the various questions.

Alternatively, the control section 100 may select an answered question from the questions in a preferential manner. This can allow the display section 210 to display the same question, that is, an answered question to which the user has input an answer, so that the user can repeatedly answer the same question.

In addition, the storage section 110 may store the number of times that a selected question is displayed on the display section 210. Where all the questions stored in the storage section 110 are answered questions, the control section 100 is allowed to select a question to be displayed on the display section 210 based on the respective numbers of times that the respective questions are displayed on the display section 210. For example, the control section 100 may cause the display section 210 to display a question that has been displayed less times or more times in a preferential manner.

The storage section 110 stores a result of determination made by the determination section 120. In other words, the storage section 110 stores the result of determination as to whether or not an answer input by the user matches the correct answer. Accordingly, the control section 100 can select a question to which an answer input by the user mismatches the correct answer from the questions in a preferential manner based on the result of determination stored in the storage section 110, and cause the display section 210 to display it. Thus, the user can repeatedly answer a question to which the user has input a wrong answer. Moreover, the storage section 110 further stores analyses corresponding to the questions. The control section 100 causes the display section 210 to display any of the analyses.

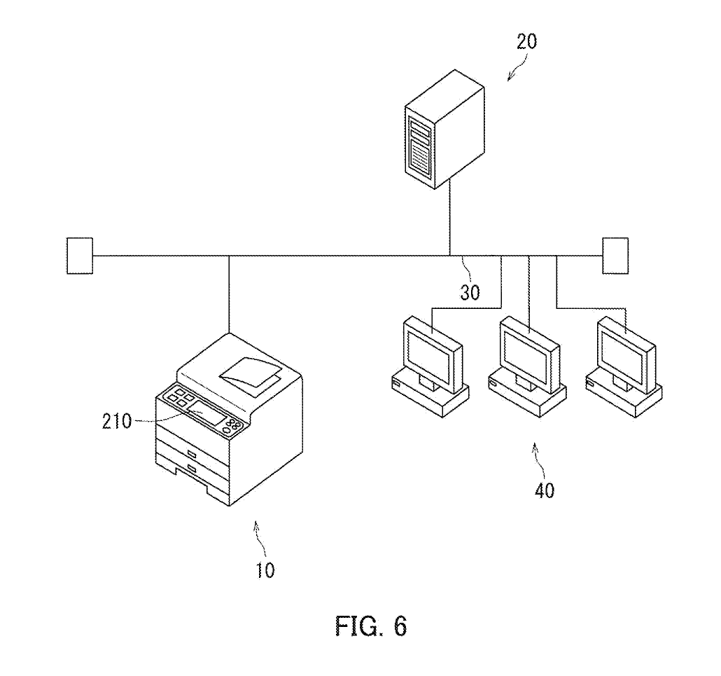

With reference to FIGS. 4 and 6, the image forming apparatus 10 connected to external devices will be discussed. FIG. 6 is a diagram illustrating the image forming apparatus 10 and external devices connected to the image forming apparatus 10. As illustrated in FIG. 6, the image forming apparatus 10 is connectable to an external server 20 as an external device via a network 30. The external devices may be flash memories such as USBs, for example. A flash memory can be connected directly to the image forming apparatus 10 not via the network 30. The external devices can store the questions and the corresponding correct answers.

The control section 100 reads at least one of a question 60 to be displayed on the display section 210 and the corresponding correct answer from the external server 20. This configuration can supplement the storage capacity of the storage section 110 included in the image forming apparatus 10, thereby reducing impairment of the performance of the image forming apparatus 10. In turn, impairment of the operability of the image forming apparatus 10 for the user in repeated question answering can be reduced.

The user operates either or both of the display section 210 and the input section 220 of the image forming apparatus 10 to update the contents of the questions (e.g., question sentences, alternatives for the questions, or corresponding analysis) and the corresponding correct answers stored in the image forming apparatus 10. As such, the user occupies the image forming apparatus 10 for update of the contents of the questions.

By contrast, when the image forming apparatus 10 is connected to the external server 20, the user can update the content of a question 60 displayed on the display section 210 by updating the contents of the questions stored in the external server 20. Thus, the user needs not to occupy the image forming apparatus 10 for update of the contents of the questions.

Note that the updating operation is not limited to updating the contents of the questions and includes adding a type of a set of questions and corresponding correct answers.

Further, as illustrated in FIG. 6, the image forming apparatus 10 is connected to users' computers 40 as well as the external server 20 via the network 30. In such a situation, any user can read out any of the questions and the correct answers from the external server 20 by operating the user's computer 40.

Thus, the user can read out a question that the user desires to answer again for learning among questions that the user has answered at the image forming apparatus 10 and display it in the user's computer 40. Where a plurality of questions and the corresponding correct answers are stored in the image forming apparatus 10, the user can read out a question that the user desires to answer again from the image forming apparatus 10 and display it in the user's computer 40. Thus, the user can repeatedly answer the question that the user desires to answer again at the user′ computer 40.

In addition, the user can transmit to the external server 20 from the image forming apparatus 10 at least one of a question displayed on the display section 210, the corresponding correct answer, and the corresponding analysis in the form of a digital document. The digital document can be transmitted to any of the computers 40 from the external server 20 via the network 30. Thus, the user can utilize the digital document to answer again the question displayed on the display section 210 at any of the computers 40.

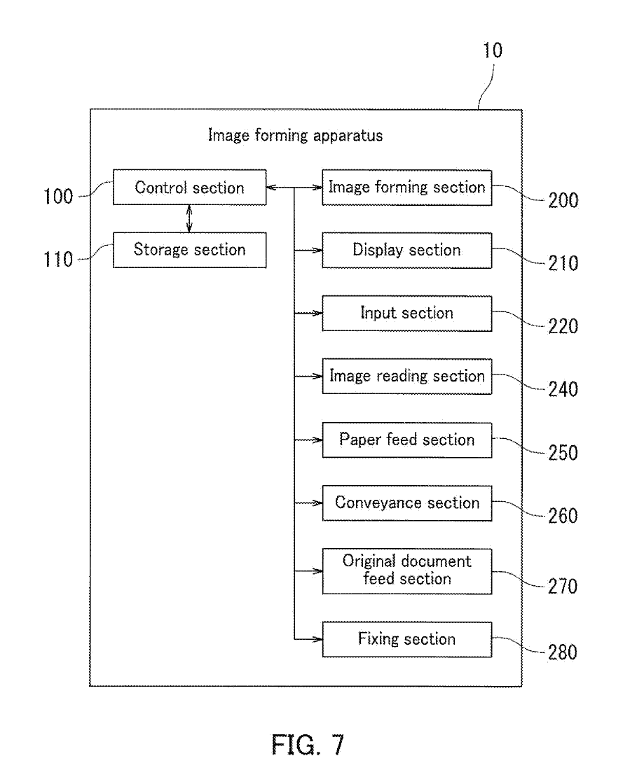

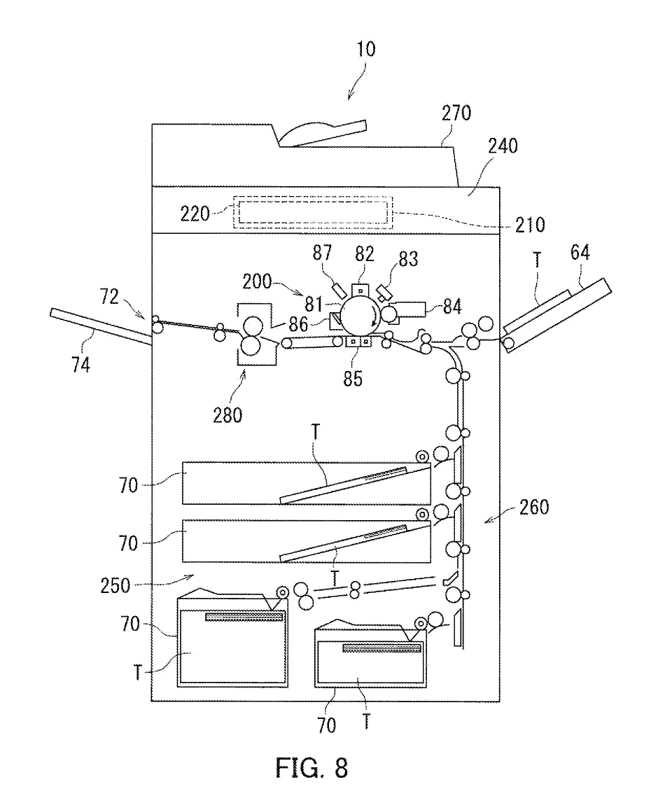

An image forming apparatus 10 according to the second embodiment will now be described with reference to FIGS. 7 and 8. FIG. 7 is a block diagram illustrating the image forming apparatus 10. FIG. 8 is a cross sectional view illustrating the image forming apparatus 10.

The image forming apparatus 10 includes the control section 100, the storage section 110, the image forming section 200, the display section 210, the input section 220, an image reading section 240, a paper feed section 250, a conveyance section 260, an original document feed section 270, and a fixing section 280. The storage section 110 includes a main storage (e.g., a semiconductor memory) and an auxiliary storage (e.g., a semiconductor memory or a hard disk drive).

The control section 100 controls the entire image forming apparatus 10. Specifically, the control section 100 executes computer programs stored in the storage section 110 to control the original document feed section 270, the image reading section 240, the input section 220, the display section 210, the paper feed section 250, the conveyance section 260, the image forming section 200, and the fixing section 280. The control section 100 may be a central processing unit (CPU), for example.

The original document feed section 270 conveys an original document to the image reading section 240. The image reading section 240 reads the image of the original document to generate image data. The paper feed section 250 incudes a paper feed cassette 70 and a manual feed tray 64. Sheets T are stacked in the paper feed cassette 70. Sheets T are sent out from the paper feed cassette 70 or the manual feed tray 64 to the conveyance section 260 on a sheet by sheet basis. The sheets T may be plain paper, recycled paper, thin paper, thick paper, overhead projector (OHP) sheets, or the like.

The conveyance section 260 conveys a sheet T to the image forming section 200. The image forming section 200 forms an image on the sheet T based on information input through the input section 220. The image formed on the sheet T may be a reading target mentioned in the first or second embodiment, a question 60 displayed on the display section 210, the correct answer to the question 60, or the analysis corresponding to the question 60, for example.

The image forming section 200 includes a photosensitive drum 81, a charger 82, an exposure section 83, a development section 84, a transfer section 85, a cleaning section 86, and a static eliminating section 87. Specifically, the image forming section 200 forms (prints) an image on the sheet T in the following manner.

The charger 82 charges the surface of the photosensitive drum 81. The exposure section 83 irradiates the surface of the photosensitive drum 81 with light based on image data generated by the image reading section 240 or image data stored in the storage section 110. This forms an electrostatic latent image corresponding to the image data on the surface of the photosensitive drum 81.

The development section 84 develops the thus-formed electrostatic latent image to form a toner image on the surface of the photosensitive drum 81. When the sheet T is fed between the photosensitive drum 81 and the transfer section 85, the toner image is transferred to the sheet T by the transfer section 85.

The sheet T to which the toner image has been transferred is conveyed to the fixing section 280. The fixing section 280 applies heat and pressure to the sheet T to fix the toner image to the sheet T. Thereafter, an ejection roller pair 72 ejects the sheet T onto the exit tray 74. The cleaning section 86 removes toner remaining on the surface of the photosensitive drum 81. The static eliminating section 87 removes residual charge on the surface of the photosensitive drum 81.

As discussed with reference to FIGS. 7 and 8, the image forming apparatus 10 according to the second embodiment can form an image on a sheet T. The image formed on a sheet T may be at least one of a question displayed on the display section 210, any question stored in the storage section 110, and any corresponding correct answer, in addition to any reading target (e.g., printed matter or a photograph).

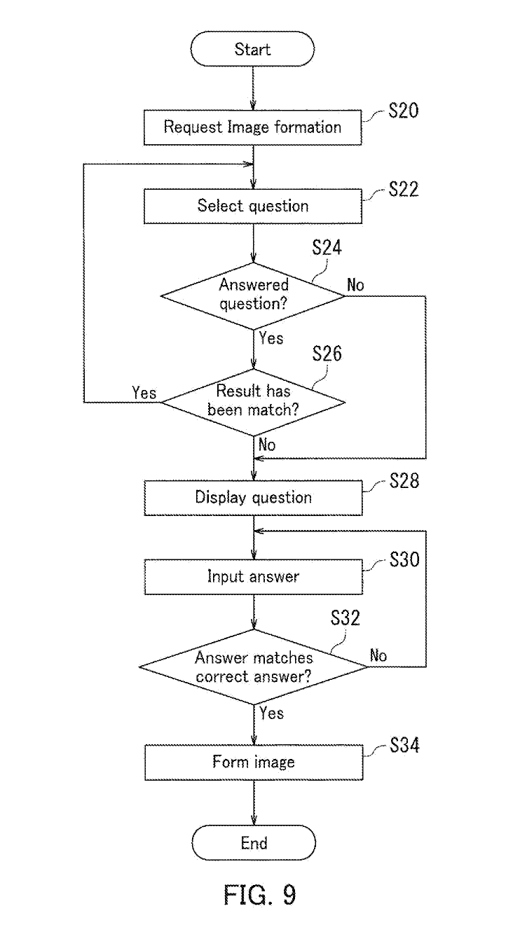

An image forming method will be described next with reference to FIGS. 4 and 9. FIG. 9 is a flowchart depicting the image forming method implemented in the image forming apparatus 10 according to the second embodiment. An image can be formed through execution of Steps S20 to S34.

At Step S20, the user requests image formation. At Step S22, the control section 100 selects a question to be displayed on the display section 210 from the questions stored in the storage section 110. At Step S24, the control section 100 determines whether or not the selected question is an answered question based on the result of determination, that is, the answered question stored in the storage section 110. At Step S24, when a positive determination is made (Yes), in other words, the selected question is an answered question, the routine proceeds to Step S26. At Step S24, when a negative determination is made (No), in other words, the selected question is an unanswered question, the routine proceeds to Step S28.

At Step S26, the control section 100 determines whether or not the user's answer to the selected answered question has matched the correct answer based on the result of determination stored in the storage section 110. At Step S26, when a positive determination is made (Yes), in other words, the correct answer to the selected question has been input, the routine returns to Step S22. Then, the control section 100 selects another question from the questions stored in the storage section 110.

At step S28, the control section 100 causes the display section 210 to display the finally selected question. At Step S30, the user inputs an answer through the input section 220. At Step S32, the determination section 120 determines whether or not the answer input by the user matches the correct answer.

At Step S32, when a positive determination is made (Yes), in other words, when the answer input by the user matches the correct answer, the routine proceeds to Step S34. At Step S34, the control section 100 causes the image forming section 200 to form an image. At Step S32, a negative determination is made (No), in other words, when the user inputs a wrong answer, the routine returns to Step S30. In this manner, the user has to continue answering until the user inputs the correct answer.

### Third Embodiment

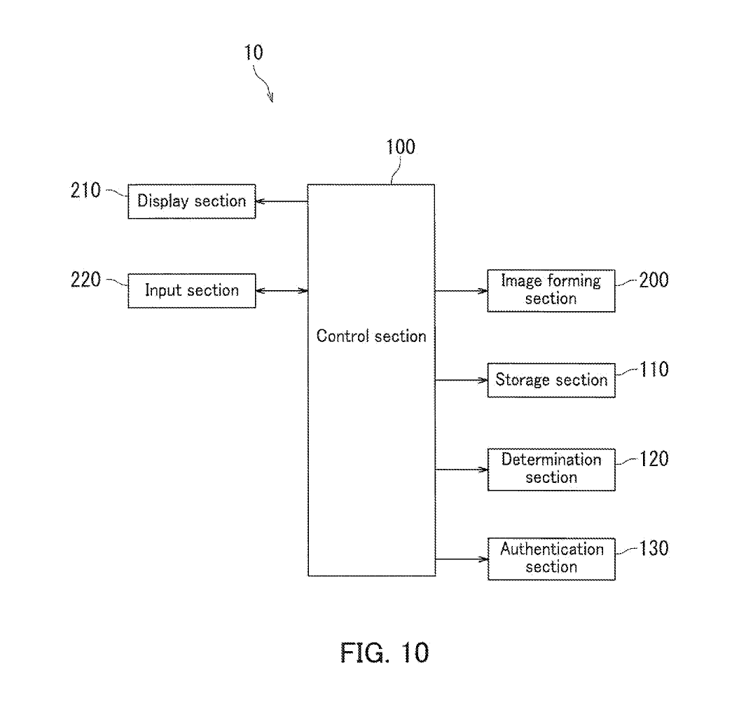

An image forming apparatus 10 according to the third embodiment of the present disclosure will be described with reference to FIG. 10. FIG. 10 is a block diagram illustrating the image forming apparatus 10. The image forming apparatus 10 further includes an authentication section 130. Note that in the image forming apparatus 10 according to the third embodiment, the same reference numerals denote the elements corresponding to those in the first and second embodiments, and the description of which will not be repeated.

The authentication section 130 authenticates identification information allotted to a user. Based on the identification information, the control section 100 selects a question 60 to be displayed on the display section 210 from the plurality of questions.

An example will be described in which a plurality of users (first and second users) use the image forming apparatus 10. The first user desires to learn English. The second user desires to learn the internal rules. In such a situation, the storage section 110 stores in advance questions relating to to-be-learned contents on a per-user basis. In other words, the storage section 110 stores questions 60 associated with identification information. In the present embodiment, the questions relating to the to-be-learned contents include questions relating to English and questions relating to the internal rules. Specifically, the questions relating to English may be stored in the storage section 110 in association with the identification information allotted to the first user, for example. On the other hand, the questions relating to the internal rules may be stored in the storage section 110 in association with the identification information allotted to the second user, for example.

Upon the authentication section 130 authenticating the identification information allotted to the first user, the control section 100 selects a question relating to English. Upon the authentication section 130 authenticating the identification information allotted to the second user, the control section 100 selects a question relating to the internal rules.

Note that the method for authenticating the identification information implemented by the authentication section 130 may be authentication using an employee ID, a password, an IC card, or the like.

The first user presses the start button for causing the image forming apparatus 10 to execute the image forming function and then inputs the identification information allotted to the first user to request image formation. The authentication section 130 performs user authentication based on the input identification information. Upon the authentication section 130 identifying the input identification information with the identification information allotted to the first user, the control section 100 causes the display section 210 to display a question relating to English that the first user desires to learn. Alternatively, if the user requesting image formation is the second user, the authentication section 130 identifies the input identification information with the identification information allotted to the second user, so that the control section 100 causes the display section 210 to display a question relating to the internal rules that the second user desires to learn.

According to the present embodiment, a question to be displayed on the display section 210 is selected from the plurality of questions based on the identification information. Accordingly, when questions associated with the identification information are stored in the storage section 110 in advance, the control section 100 can select a question 60 to be displayed on the display section 210 on a per-user basis. The user accordingly can learn through repetitive answering to questions relating to the content that the user desires to learn out of the plurality of questions.

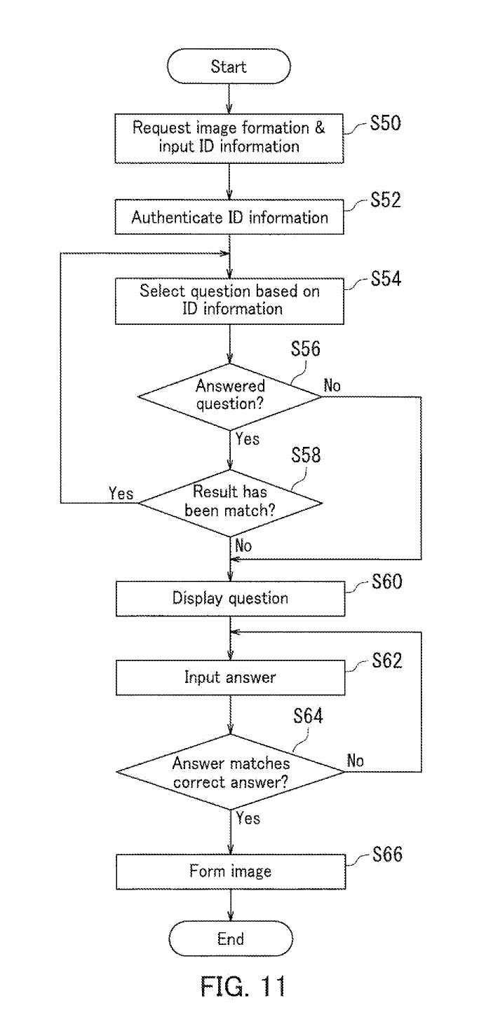

An image forming method that the control section 100 employs will be described with reference to FIGS. 6, 10, and 11. FIG. 11 is a flowchart depicting the image forming method according to the third embodiment.

At Step S50, a user presses the start button for causing the image forming apparatus 10 to execute the image forming function and then inputs the identification information allotted to the user to request image formation. At Step S52, the authentication section 130 performs user authentication based on the identification information input by the user. At step S54, the control section 100 selects a question to be displayed on the display section 210 based on the identification information. At Step S56, the control section 100 determines whether or not the selected question is an answered question. When a positive determination is made (Yes) at Step S56, the routine proceeds to Step S58. When a negative determination is made (No) in Step S56, the routine proceeds to Step S60.

At Step S58, the control section 100 determines whether or not a result of determination having been made by the determination section 120 is a match. When a positive determination is made (Yes) at Step S58, the routine returns to Step S54. When a negative determination is made (No) at Step S58, the routine proceeds to Step S60.

At step S60, the control section 100 causes the display section 210 to display the selected question. At Step S62, the user inputs an answer through the input section 220. At Step S64, the determination section 120 determines whether or not the answer input by the user matches the correct answer. When a positive determination is made (Yes) at Step S64, the routine proceeds to Step S66. When a negative determination is made (No) at Step S64, in other words, when the user inputs a wrong answer, the routine returns to Step S62. In this manner, the user continues answering until the user inputs the correct answer. At Step S66, the image forming section 200 forms an image.

The first to third embodiments have been discussed so far with reference to FIGS. 1-11. It should be note that the present disclosure is not limited to the above embodiments, and various alterations may be made without departing from the scope of the present disclosure. For example, the following alterations are possible.

(1) As described with reference to FIG. 2, the display section 210 displays a question 60 in response to user's request for image formation. While, the user can request image formation even in a situation in which the control section 100 causes the display section 210 to display a question.

(2) As described with reference to FIG. 2, the user selects an alteration as an answer to a question 60 displayed on the display section 210 from the alterations in the button group 62 and inputs it. While, provision of a region that enables the user to input characters in the display section 210 can allow the user to an answer by inputting a character. The characters to be input may include Hiragana characters, Katakana characters, alphabet, and numerals, for example.

(3) As described with reference to FIG. 6, at least one of a question displayed on the display section 210, the corresponding correct answer, and the corresponding analysis is transmitted in the form of a digital document to any computer 40. While, media to which a digital document is transmitted are not limited to the computers 40 and may be any of personal computers, mobile phones, and tablet terminals.

(4) As described with reference to FIGS. 7 and 8, the image forming section 200 forms on a sheet T an image of any of a question displayed on the display section 210, the corresponding correct answer, or the corresponding analysis. While, the image forming section 200 may form on a sheet T an image representing information stored in the storage section 110 or information transmitted from the external server 20 as an external device. Such the information may include coupon information, advertisement, and What's New in the company, for example.

What is claimed is:

1. An image forming apparatus, comprising:
an image forming section configured to form an image;
a display section configured to display a question;
an input section configured to receive an answer to the question as input from a user; and
a control section configured to cause the image forming section to form an image in response to input of the answer.

2. The image forming apparatus according to claim 1, further comprising
a determination section configured to determine whether or not the input answer matches a correct answer.

3. The image forming apparatus according to claim 2, wherein
upon a match between the input answer and the correct answer, the control section causes the image forming section to form an image.

4. The image forming apparatus according to claim 2, further comprising
a storage section configured to store a plurality of questions,
wherein the storage section stores a question to which the user has input an answer, among the plurality of questions, as an answered question, and
the control section selects a question to be displayed on the display section from the questions by referencing the answered question.

5. The image forming apparatus according to claim 4, wherein
the storage section stores a result of determination made by the determination section, and
the control section selects a question to be displayed on the display section from the questions based on the result.

6. The image forming apparatus according to claim 4, further comprising
an authentication section configured to authenticate identification information allotted to the user,
wherein the control section selects a question to be displayed on the display section from the questions by referencing the identification information.

7. The image forming apparatus according to claim 5, wherein
the storage section further stores analyses corresponding to the questions, and
the control section causes the display section to display any of the analyses.

8. The image forming apparatus according to claim 7, wherein
the control section reads out from an external device either one of a question to be displayed on the display section and a correct answer corresponding to the question.

9. The image forming apparatus according to claim 8, wherein
at least one of the question displayed on the display section, the correct answer corresponding to the question, and an analysis corresponding to the question is transmitted in a form of a digital document to the external device.

10. The image forming apparatus according to claim 8, wherein
the image forming section forms an image representing information transmitted from the storage section or the external device on a sheet.

11. The image forming apparatus according to claim 6, wherein
the storage section stores a question associated with the identification information.

12. The image forming apparatus according to claim 7, wherein
the image forming section forms on a sheet, an image representing at least one of a question displayed on the display section, a correct answer corresponding to the question, and an analysis corresponding to the question.

13. The image forming apparatus according to claim 4, wherein
the image forming section forms on a sheet, an image representing information stored in the storage section.

14. The image forming apparatus according to claim 8, wherein
the image forming section forms on a sheet, an image representing information transmitted from the external device.
